(19) United States
(12) Patent Application Publication
(10) Pub. No.: US 2011/0269612 A1
(43) Pub. Date: Nov. 3, 2011

(54) FOLDING APPARATUS FOR ELECTROPHOTOGRAPHIC PRINTS

(76) Inventors: Thomas N. Tombs, Rochester, NY (US); Donald S. Rimai, Webster, NY (US); Brian J. Kwarta, Pittsford, NY (US)

(21) Appl. No.: 12/771,287

(22) Filed: Apr. 30, 2010

(51) Int. Cl. B41L 43/02; B31F 1/08

(52) U.S. Cl. 493/320; 493/405

(57) ABSTRACT

Systems for folding a receiver having a dry toner thermally fused thereon are provided. In one aspect, a system for folding has a wetting system adapted to apply water along a fold line and a fold mechanism folding the receiver along the fold line. The folding is performed after a predetermined absorption period during which at least a portion of the applied water is absorbed by the receiver to reduce the extent to which the receiver cracks proximate the fold line during folding.

### CROSS REFERENCE TO RELATED APPLICATIONS

This application relates to commonly assigned, copending U.S. application Ser. No. ______ (Docket No. 96241RRS), filed ______, entitled: “FOLDING METHOD FOR ELECTROPHOTOGRAPHIC PRINTS” hereby incorporated by reference.

### FIELD OF THE INVENTION

This invention relates to methods and apparatuses that are used to fold fused electrophotographic prints.

### BACKGROUND OF THE INVENTION

Electrophotographic printing requires the precise placement of many highly charged toner particles in close proximity to one another, first on a photoreceptor, then transferred to a paper or other receiver in the form of a toner image. The toner image is ultimately fixed to the paper through a process known as fusing. Typically, fusing involves applying heat and optionally pressure to a receiver to cause toner on a receiver to heat to a glass transition temperature and bond to the receiver. The heat and pressure applied during fusing makes the toner image formed on the receiver more rigid and less flexible.

While the end product of an electrophotographic printing system is a printed document that is a valuable item, substantial value can be added by converting the printed pages into a finished good. Such conversion often requires folding the printed pages. For example, printed pages can be folded to form bound signatures that can be used to make booklets or books. Accordingly, the bending of electrophotographic prints to make folds such as those that are incorporated in finished products such as books, book pages, greeting cards, menus and the like is highly valuable.

However, as is illustrated in FIG. 1, when a receiver 2 such as a paper having a relatively inflexible fused toner image 4 fixed to paper fibers 6 forming the receiver 2 is bent, the toner image 4 tends to fracture, resulting in a finished product that is less than satisfactory at the fold.

There have been efforts to provide folding systems that can fold toner images without cracking the images that are recorded on them. One mechanism of this type is the BCMe rotary creaser sold by CP Bourg, New Bedford, Mass., USA. This mechanism is an electronically registered rotary creaser that creases a receiver in the area of a fold to reduce the incidence of toner cracking. Another mechanism, the Morgana DigiFold, sold by Morgana Systems Ltd., Milton Keynes, U.K., forms a crease in a receiver before folding. This is said to eliminate a cause of cracking at the fold.

Both of these mechanisms require that the receiver be subject to two mechanical fabrication processes to achieve a reduced incidence of toner cracking at the fold. This carries with it a risk that such mechanical fabrication processes will cause other damage to the receiver as it is processed and handled.

What is needed are method and an apparatus that enable the folding of receivers having toner images fused thereto with minimal damage to the toner image or the underlying receiver and that can be incorporated into a consumer or retail grade equipment and processes.

### SUMMARY OF THE INVENTION

Systems for folding a receiver having a dry toner thermally fused thereon are provided. In one aspect, a system for folding has a wetting system adapted to apply water along a fold line and a fold mechanism folding the receiver along the fold line. The folding is performed after a predetermined absorption period during which at least a portion of the applied water is absorbed by the receiver to reduce the extent to which the receiver cracks proximate the fold line during folding.

### BRIEF DESCRIPTION OF THE DRAWINGS

FIG. 1 is a graphic illustration of cracking of a toner image that can occur when a receiver on which the toner image is folded after fusing;

FIG. 2 is a system level illustration of one embodiment of an electrophotographic printer.

FIG. 3 shows an embodiment of a folding system;

FIG. 4 shows an embodiment of a folding method;

FIG. 5 shows an embodiment of a wetting system;

FIGS. 6-9 show an embodiment of a fold mechanism folding a receiver;

FIG. 10 shows an embodiment of a water delivery system used in a wetting system;

FIG. 11 shows another embodiment of a water delivery system used in a wetting system;

FIG. 12 shows another embodiment of a water delivery system for use in a wetting system;

FIG. 13 shows another embodiment of a water delivery system for use in a wetting system.

FIG. 14 shows another embodiment of a water delivery system for use in a wetting system;

FIG. 15 shows another embodiment of a water delivery system for use in a wetting system;

FIG. 16 shows an embodiment of a water delivery system for use in a wetting system;

FIG. 17 shows another embodiment of a water delivery system for use in a wetting system.

FIG. 18 shows an embodiment of a printing method; and

FIG. 19 shows a pattern of fold lines and hydrated areas that are arranged along different axes to allow multiple folds of a receiver.

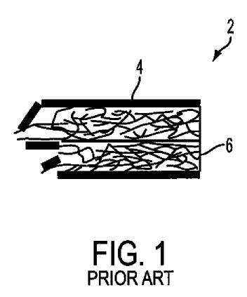

### DETAILED DESCRIPTION OF THE INVENTION

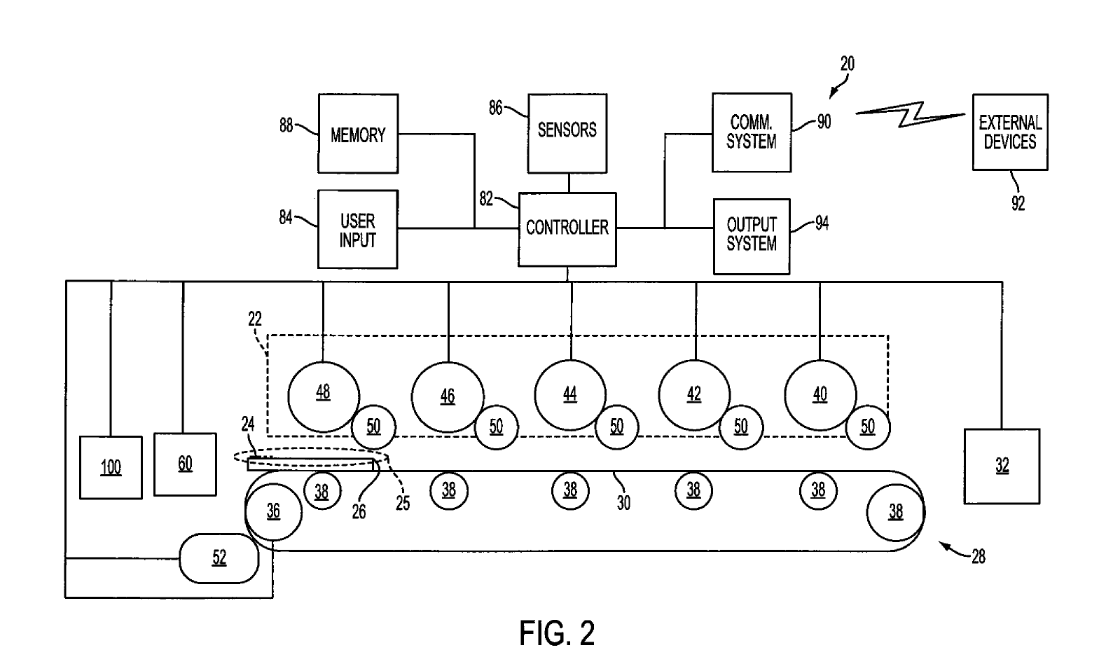

FIG. 2 is a system level illustration of an electrophotographic printer 20. In the embodiment of FIG. 2, electrophotographic printer 20 has an electrophotographic print engine 22 that deposits dry toner 24 to form a toner image 25 in the form of a patterned arrangement of toner stacks. Toner image 25 can include any patternwise application of toner 24 and can be mapped according data representing text, graphics, photo, and other types of visual content, as well as patterns that are determined based upon desirable structural or functional arrangements of the applied toner 24.

Toner 24 is a material or mixture that contains toner particles, and that can form an image, pattern, or coating when electrostatically deposited on an imaging member including a photoreceptor, photoconductor, electrostatically-charged, or magnetic surface. As used herein, “toner particles” are the marking particles used in an electrophotographic print engine 22 to convert an electrostatic latent image into a visible image. Toner particles can also include clear particles that can provide, for example, a protective layer on an image or that impart a tactile feel to the printed image.

Toner particles can have a range of diameters, e.g. less than 8 μm, on the order of 10-15 μm, up to approximately 30 μm, or larger. When referring to particles of toner 24, the toner size or diameter is defined in terms of the median volume weighted diameter as measured by conventional diameter measuring devices such as a Coulter Multisizer, sold by Coulter, Inc. The volume weighted diameter is the sum of the mass of each toner particle multiplied by the diameter of a spherical particle of equal mass and density, divided by the total particle mass. Toner 24 is also referred to in the art as marking particles or dry ink.

Typically, receiver 26 takes the form of paper, or coated paper. However, receiver 26 can take any number of forms and can comprise, in general, any article or structure that can be moved relative to print engine 22, and that has a moisture content.

Print engine 22 can be used to deposit one or more applications of toner 24 to form toner image 25 on receiver 26. A toner image 25 formed from a single application of toner 24 can, for example, provide a monochrome image.

A toner image 25 formed from more than one application of toner 24 (also known as a multi-part image) can be used for a variety of purposes, the most common of which is to provide toner images 25 with more than one color. For example, in a four toner image, four toners having subtractive primary colors, cyan, magenta, yellow, and black, can be combined to form a representative spectrum of colors. Similarly, in a five toner image various combinations of any of five differently colored toners can be combined to form other colors on receiver 26 at various locations on receiver 26. That is, any of the five colors of toner 24 can be combined with toner 24 of one or more of the other colors at a particular location on receiver 26 to form a color different than the colors of the toners 24 combined at that location.

In the embodiment that is illustrated, a primary imaging member (not shown) such as a photoreceptor is initially charged. An electrostatic latent image is formed by image-wise exposing the primary imaging member using known methods such as optical exposure, an LED array, or a laser scanner. The electrostatic latent image is developed into a visible image by bringing the primary imaging member into close proximity to a development station that contains toner 24. The toned image on the primary imaging member is then transferred to receiver 26, generally by pressing receiver 26 against the primary imaging member while subjecting the toner to an electrostatic field that urges the toner to receiver 26. The toner image 25 is then fixed to receiver 26 by fusing.

In the embodiment of FIG. 2 print engine 22 is illustrated as having an optional arrangement of five printing modules 40, 42, 44, 46, and 48, also known as electrophotographic imaging subsystems arranged along a length of receiver transport 28. Each printing module delivers a single application of toner 24 to a respective transfer subsystem 50 in accordance with a desired pattern as receiver 26 is moved by receiver transport 28. Receiver transport 28 comprises a movable surface 30 that accepts a receiver 26 from a receiver supply 32 and moves receiver 26 relative to printing modules 40, 42, 44, 46, and 48. Surface 30 comprises an endless belt that is moved by motor 36, that is supported by rollers 38, and that is cleaned by a cleaning mechanism 52.

After toner image 25 is formed on receiver 26, receiver 26 is moved by receiver transport 28 to thermal fuser 60. Thermal fuser 60 applies heat and, optionally, pressure to receiver 26 and toner image 25 to cause the toner 24 forming toner image 25 to enter into a glassy state that converts toner image 25 into a solid mass and that bonds toner image 24 to receiver 26. A wide variety of conventional fusers are known that use heat to induce fusing and that can be applied for this purpose.

Referring again to FIG. 2, electrophotographic printer 20 is operated by a controller 82 that controls the operation of print engine 22 including but not limited to each of the respective printing modules 40, 42, 44, 46, and 48, receiver transport 28, receiver supply 32, transfer subsystem 50, to form a toner image 25 on receiver 26 and to cause fuser 60 to fuse toner images 25 on receiver 26 in accordance with the methods claimed herein.

Controller 82 operates electrophotographic printer 20 based upon input signals from a user input system 84, sensors 86, a memory 88 and a communication system 90. User input system 84 can comprise any form of transducer or other device capable of receiving an input from a user and converting this input into a form that can be used by controller 82. For example, user input system 84 can comprise a touch screen input, a touch pad input, a 4-way switch, a 6-way switch, an 8-way switch, a stylus system, a trackball system, a joystick system, a voice recognition system, a gesture recognition system or other such systems. Sensors 86 can include contact, proximity, magnetic, or optical sensors and other sensors known in the art that can be used to detect conditions in electrophotographic printer 20 or in the environment-surrounding electrophotographic printer 20 and to convert this information into a form that can be used by controller 82 in governing printing and fusing. Memory 88 can comprise any form of conventionally known memory devices including but not limited to optical, magnetic or other movable media as well as semiconductor or other forms of electronic memory. Memory 88 can be fixed within electrophotographic printer 20, removable from electrophotographic printer 20 at a port, memory card slot or other known means for temporarily connecting a memory 88 to an electronic device. Memory 88 can also be connected to electrophotographic printer 20 by way of a fixed data path or by way of communication system 90.

Communication system 90 can comprise any form of circuit, system, or transducer that can be used by controller 82 to send signals to or to receive signals from memory 88 or external devices 92 that are separate from or separable from direct connection with controller 82. Communication system 90 can connect to external devices 92 by way of a wired or wireless connection. In certain embodiments, communication system 90 can comprise a circuitry that can communicate with such separate or separable device using a wired local area network or point to point connection such as an Ethernet connection. In certain embodiments, communication system 90 can alternatively or in combination provide wireless communication circuits for communication with separate or separable devices using a Wi-Fi or any other known wireless communication systems. Such systems can be networked or point to point communication.

External devices 92 can comprise any type of electronic system that can generate wireless signals bearing data that may be useful to controller 82 in operating electrophotographic printer 20. For example and without limitation, an external device 92 can comprise what is known in the art as a digital front end (DFE), which is a computing device that can be used to provide images and or printing instructions to electrophotographic printer 20.

An output system 94, such as a display, is optionally provided and can be used by controller 82 to provide human perceptible signals for feedback, informational or other purposes. Such signals can take the form of visual, audio, tactile or other forms.

In the embodiment shown in FIG. 2, a folding system 100 is provided to fold receiver 26 after the toner image 25 has been fused by fuser 60. As discussed above receiver 26 and the toner image 25 fused thereto are not readily susceptible to bending and folding.

In particular, it will be understood that, in many cases, receiver 26 is a fibrous type material such as paper or cardboard or the like formed principally from cellulosic fibers. Receiver 26 such as paper having cellulosic fibers is normally manufactured to a moisture content equivalent to being equilibrated to 40% to 50% relative humidity. Such a paper type receiver 26 is dried by the heat of fuser 60 to an equivalent moisture content of approximately 5% relative humidity. Such dry receiver 26 cracks badly when bent. These cracks contribute significantly to breakdown of toner image 25 during folding. Any receiver 26 that absorbs moisture can be similarly effected by fusing. Accordingly, addressing the cracking caused by dehydration of receiver 26 is a key to enable folding of a fused receiver 26, without damage to a toner image 25 thereon.

However, generally remoisturizing a receiver 26 of this type after fusing would not work because receiver 26 would cockle creating bending and warping receiver 26 making the resulting prints unacceptable. Moreover, as receiver 26 absorbs moisture it would swell and create stresses within the regions of toner image 25 having significant toner laydown. These regions then crack and/or delaminate. Folding system 100 provides a folding solution that allows a folding of receiver 26 and toner image 25 that has been fused with reduced cracking of toner image 25.

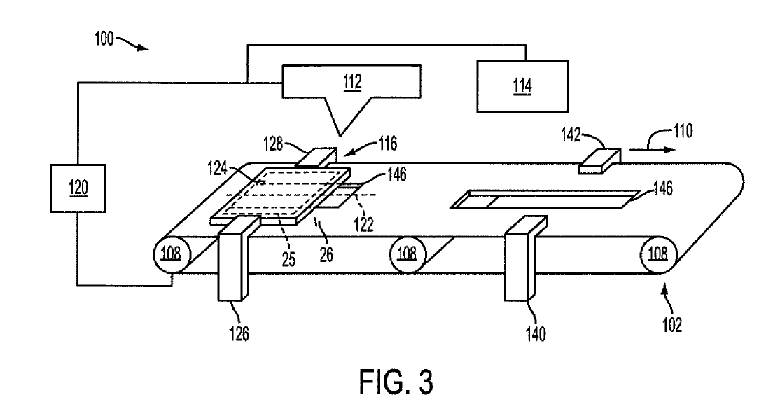

As is shown in the embodiment of FIG. 3, folding system 100 has a receiver advance 102, a wetting system 112, a fold mechanism 114 and a fold controller 120. Receiver advance 102 accepts a receiver 26 with a toner image 25 (shown in phantom) and positions receiver 26, wetting system 112 and fold mechanism 114 so that they can cooperate as described below.

Receiver advance 102 is shown taking the form of an endless belt 104 that is supported by rollers 106 and driven by a motor 108 to move receiver 26 along a path of travel 110 past wetting system 112 to fold mechanism 114. As is shown in FIG. 3, in this embodiment one or more gaps 146 can be provided in endless belt 104 for purposes that will be described below. In other embodiments, receiver advance 102 can comprise a movable platen, air cushion conveyor system, or other structure that can be used to properly position receiver 26 as described herein.

Fold controller 120 provides logical control of receiver advance 102, wetting system 112, and fold mechanism 114 and can comprise for example, an electronic processor or controller or the like. In embodiments where folding system 100 is provided as a stand alone device that is used in cooperation with a printer 20, fold controller 120 is integral to folding system 100. Where folding system 100 is incorporated in a printer 20 or serves as a modular attachment to the same, fold controller 120 can optionally cooperate with printer controller 82 system, or printer controller 82 can perform the functions of fold controller 120.

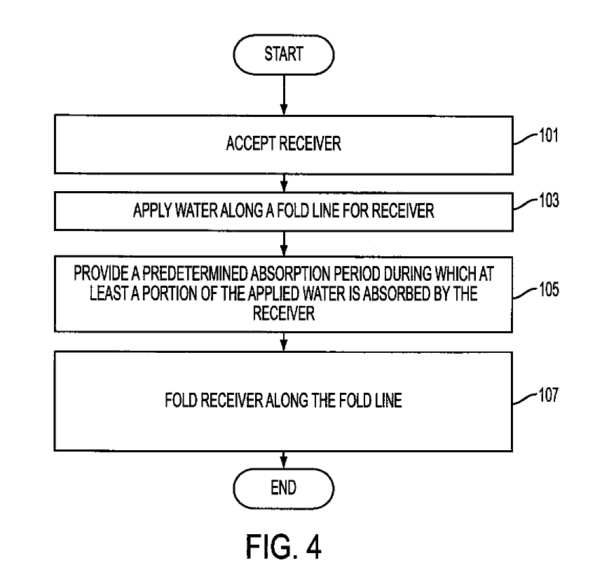

FIG. 4 shows one embodiment of a method for folding a receiver 26 having a fused toner image 25 that can be used for example with folding system 100 in FIG. 3. As is illustrated in FIG. 4, when a receiver 26 is accepted (step 101) fold controller 120 causes receiver advance 102 to move receiver 26 to wetting system 112 and causes wetting system 112 to apply water 116 along a fold line 122 for receiver 26 (step 103). A predetermined absorption period is provided during which at least a portion of the applied water 116 is absorbed by receiver 26 (step 105). This reduces the extent to which receiver 26 cracks proximate to fold line 122 during folding. In certain embodiments, receiver advance 102 is arranged so that the time required to move receiver 26 from wetting system 112 to fold mechanism 114 provides the required absorption period. In other embodiments, fold controller 120 can delay the transport of receiver 26 to fold mechanism 114 for the predetermined delay period.

Water 116 is absorbed in hydrated area 124 during the absorption period increases the relative humidity of receiver 26 in hydrated area 124. The increased relative humidity at fold line 122 will reduce the risk that receiver 26 will crack or cause toner image 25 to crack during folding. The extent to which such an increase is required to substantially eliminate the incidence of cracking can vary based upon the type of materials used to make receiver 26, the properties of any coatings applied thereto and the effects of fusing on receiver 26. In some embodiments, a relative humidity in the hydrated area 124 of at least about 70 percent can be provided. In other embodiments for example, any relative humidity of less than about 90 can be provided.

As noted above, the generalized wetting of a fused receiver 26 is limited to prevent overwetting of receiver 26. Accordingly, a general wetting of receiver 26 is avoided. Instead, as shown in FIG. 3, wetting is performed to an extent that forms a hydrated area 124 proximate to fold line 122. In one embodiment, water 116 is applied so that hydrated area 124 is about 1 millimeter wide about fold line 122. In other embodiments, water 116 can be applied such that hydrated area 124 can range up to about 3 mm wide about fold line 122 or wider depending on the absorption properties of receiver 26 and any toner image 25 formed thereon. Accurate registration of water 116 applied by wetting system 112 and fold mechanism 114 is provided to ensure that folding is performed in hydrated area 124. As will be discussed in greater detail below, in this embodiment of folding system 100 registration features 126 and 128 and alignment features 140 and 142 are used, respectively, to align receiver 26 during wetting and folding to provide such registration. In other embodiments other types of positioning systems can be used to ensure that fold mechanism 114 folds in hydrated area 124. In still other useful embodiments, alignment features can be provided to ensure that folding is registered with the position of toner image 25 and with hydrated area 124.

After the predetermined absorption period, receiver 26 is moved to fold mechanism 114 which mechanically folds receiver along fold line 122 (step 107). In the embodiment illustrated in FIG. 3, fold mechanism 114 is adapted to provide a single fold on receiver 26, for example to create greeting cards, menus, booklet pages and the like. Accordingly, in this embodiment, water 116 need only be applied to form a single hydrated area 124 proximate to fold line 122. In other embodiments, where fold mechanism 114 is adapted to provide more than one fold along more than one fold line, water 116 can be applied along each of the more than one fold lines.

In the example illustrated in FIG. 3, fold line 122 is parallel to path of travel 110 of receiver 26 as receiver 26 is moved by receiver advance 102, accordingly wetting system 112 and fold mechanism 114 are adapted to apply water 116 and to fold a receiver 26 that is moved in this fashion.

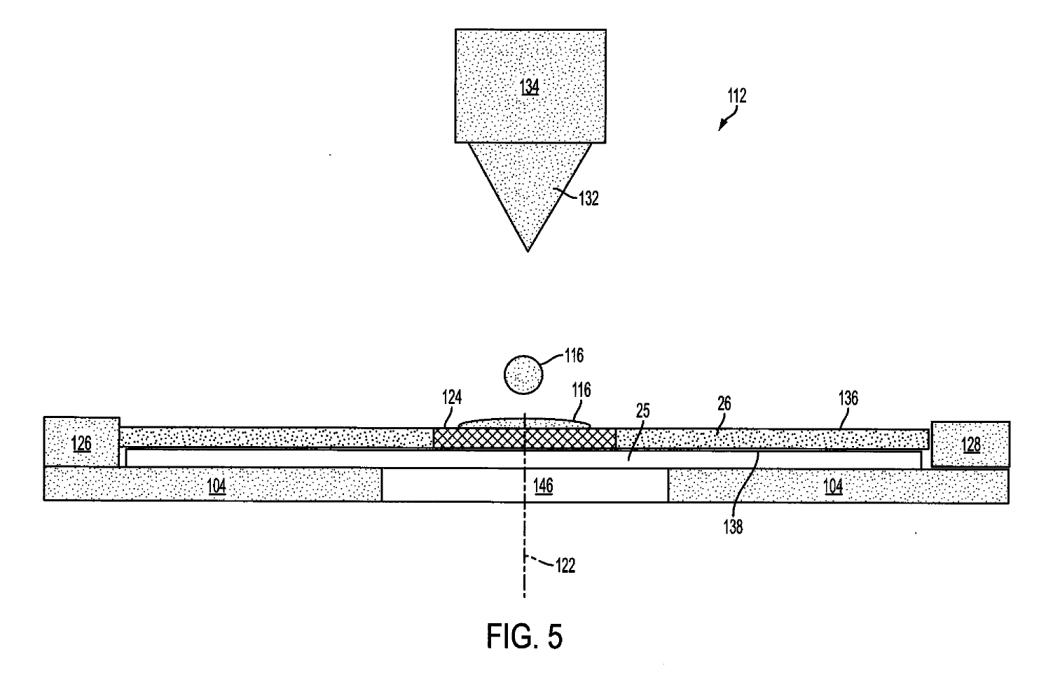

FIG. 5 shows a cross section view of a first embodiment of a wetting system 112 that can be used in, for example, the embodiment of folding system 100 shown in FIG. 3 to form a hydrated area 124 that is parallel to the path of travel 110. In this embodiment, wetting system 112 applies water 116 along a single point or across a limited width of receiver 26 as receiver 26 is moved past wetting system 112.

Wetting system 112 has a water delivery system 132 and a control system 134 that controls the delivery of water 116 by water delivery system 132. In this embodiment, water 116 begins to flow from water delivery system 132 toward receiver 26 when a leading edge of receiver 26 reaches a first point in path of travel 110 and ceases when a trailing edge of receiver 26 reaches a second point in path of travel 110. Control system 134 can comprise for example conventional fluid control systems and structures such as controllable valves and the like. Control system 134 will generally be responsive to fold controller 120 which can use one or more edge sensors (not shown) to detect the leader and trailing edges of receiver. The flow of water 116 can be in made in any form and in any quantity, i.e. drops, a stream of water, etc. required to form a hydrated area 124 in receiver 26 without overwetting. The flow of water 116 can be gravity fed, jetted, or otherwise pressurized as desired. As illustrated in FIG. 5, in this embodiment, water 116 is delivered in droplets.

The flow of water 116 provided by wetting system 112 is positioned relative to a width of receiver 26 through the use of registration features 126 and 128 which engage edges of receiver 26 to position receiver 26 such that water 116 is applied proximate to fold line 122.

Water 116 that is applied to receiver 26 is given a predetermined absorption period to allow water 116 to be absorbed by receiver 26 before folding. This forms hydrated area 124 in receiver 26 when receiver 26 reaches fold mechanism 114. In certain embodiments, the absorption period will be less than five seconds, in other embodiments, the absorption period can be two seconds or less. However, the amount of time required for absorption can vary depending on the absorption rate of receiver 26, the thickness of receiver 26, various properties of coatings applied to receiver 26 such that other absorption times are possible. For example, receivers 26 that are thick or that have coatings that will delay water absorption, such as those commonly used in the graphic arts industry would generally require longer absorption times than would thinner papers or non-coated papers such as laser bond paper. In this regard, at least one setting controlling the application of water 116 to receiver 26 can be based upon absorption properties of the receiver 26, a thickness of receiver 26, the composition of receiver 26, environmental conditions at folding system 100, the way in which receiver 26 has been fused, the temperature at which receiver 26 has been fused, the composition of toner 24, whether water 116 is to be applied to a toner 24 covered portion of receiver 26. Examples of such settings can comprise the length of the absorption period, an amount of water 116, a width of hydrated area 124, a temperature of water 116, a pressure used to apply water 116, and/or whether to use additives in water 116.

In FIG. 5, water 116 is shown as being applied to receiver 26 on the opposite side of receiver 26 to which a simplex toner image 25 has been deposited and fused. This limits the extent to which toner applied to receiver 26 will interfere with the moistening of receiver 26. However, in other embodiments water 116 can be applied to a side of receiver 26 that has a toner image 25 recorded thereon. This can be done for example, where toner image 25 can transmit sufficient moisture during an absorption period to create hydrated area 124 in receiver 26 or where there are gaps in toner image 25 such as those created by half-toning processes that allow water penetration into receiver 26 during an absorption period without substantial interference from toner image 25.

In various embodiments, controller 82 can determine when a fold line will pass through a toner image and can provide gaps in the toner along fold line 122 to facilitate wetting of receiver through toner image 25.

In one embodiment where a toner image 25 is on a side of receiver 26 to which water 116 is to be applied, the pattern of water 116 applied by wetting system 112 can be varied to provide water only in regions of receiver 26 within toner image 25 where toner lay down is minimized, to the extent that this still allows sufficient wetting of fibers in the higher toner density regions to achieve the desired result of reduced risk of damage to toner image 25 during folding. This can be done for example by providing a control system 134 that is capable of selectively applying water to selected portions of receiver 26 having such low toner lay down according for example to image content or according to detected toner laydown densities.

It will be understood that second side 138 of receiver 26 having toner image 25 will form an outside portion of a fold of receiver 26. This outside portion experiences the greatest tensional stress during folding, requiring that fibers of receiver 26 be capable of bending with low cracking so that toner image 25 has a lower incidence of damage when folded. In this embodiment, water 116 is applied to a first side 136 of receiver 26 that will form an inside corner of receiver 26 when folded. This allows water to be absorbed by receiver 26 which can occur faster than by applying the water to the side on which toner image 25 is recorded.

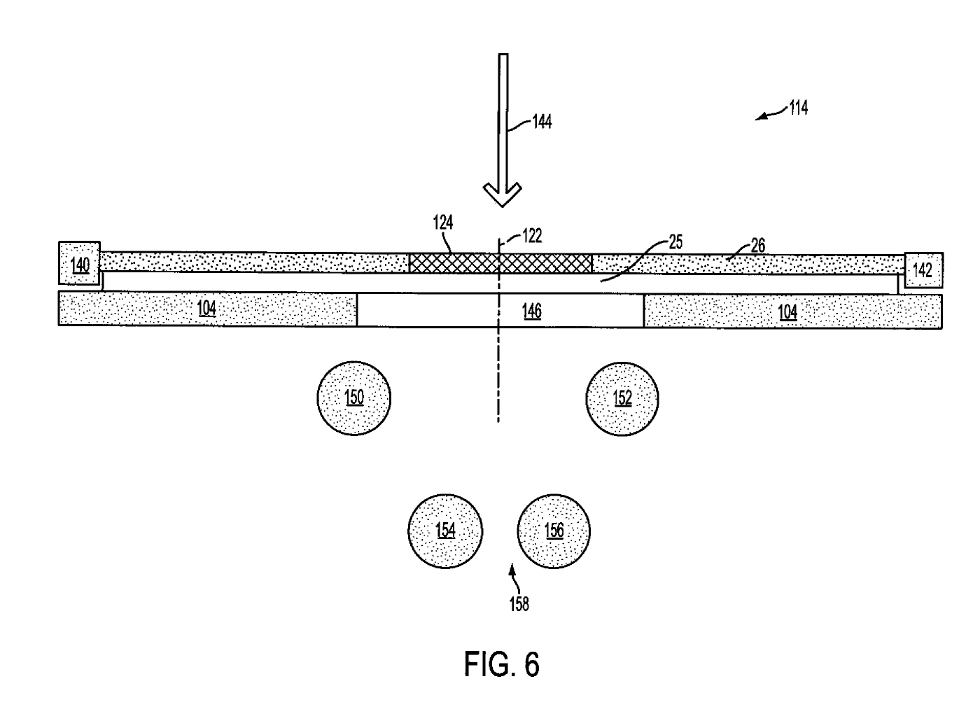

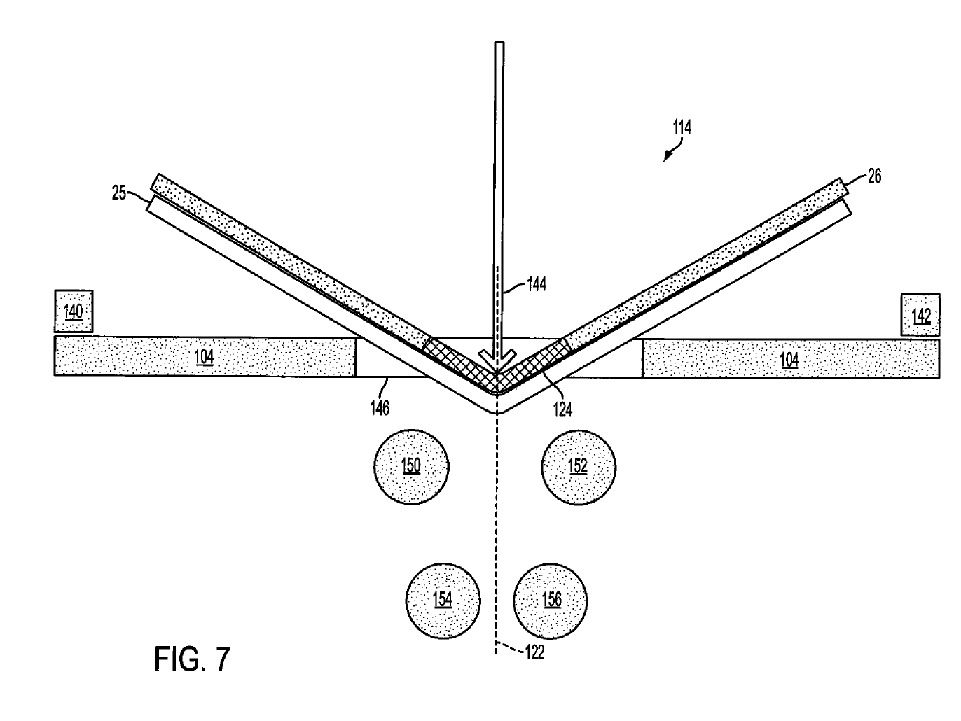

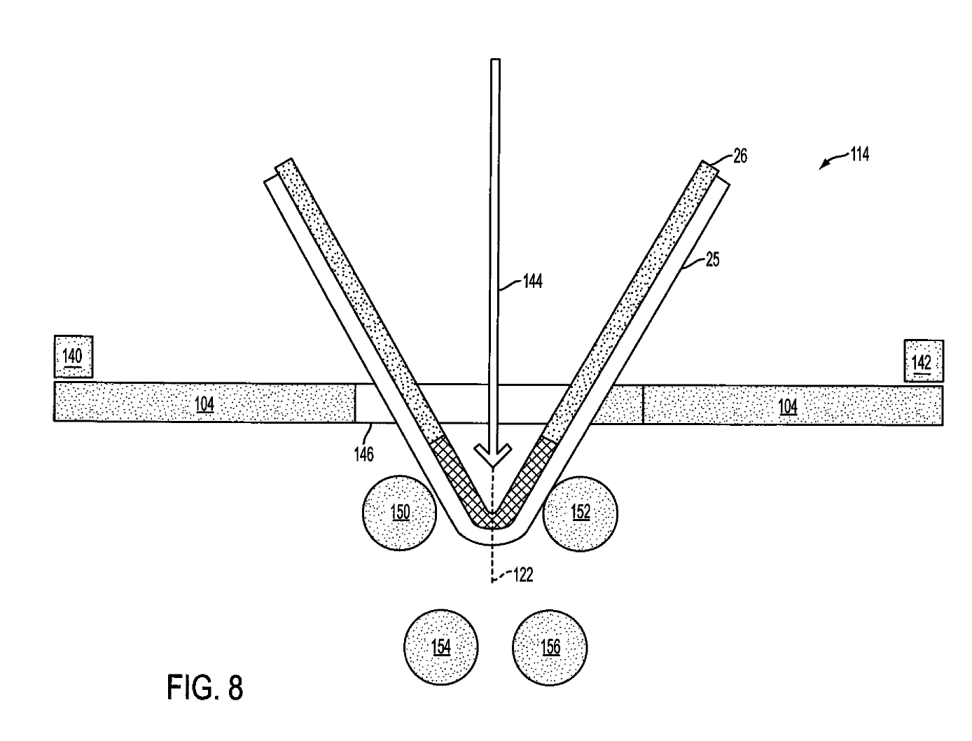

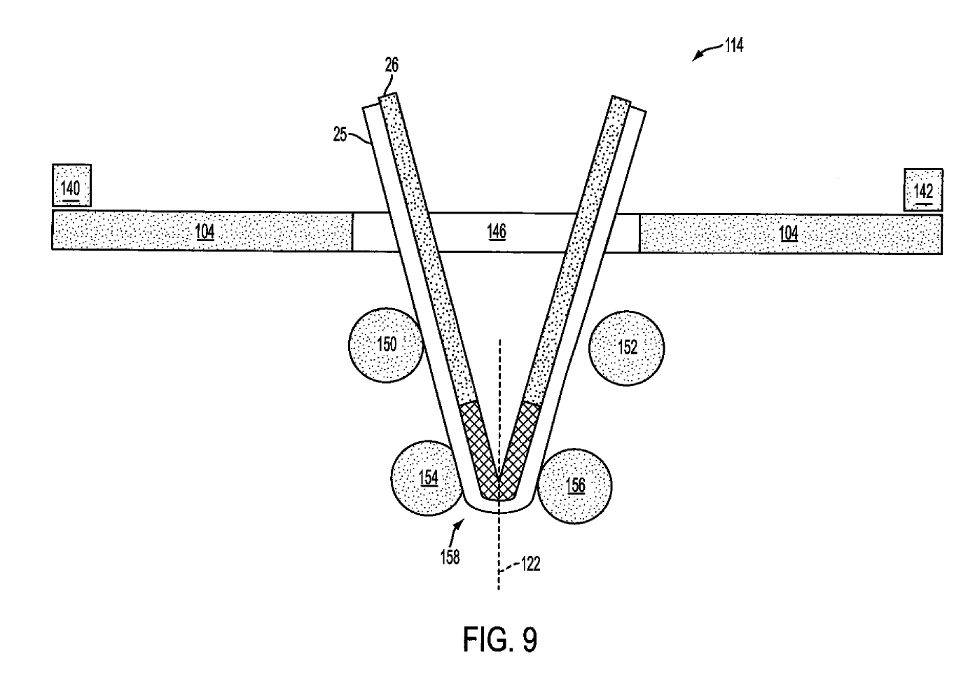

FIG. 6 illustrates one embodiment of a fold mechanism 114 that can be used to fold a receiver 26 having a hydrated area 124. As is shown in FIG. 6, alignment features 140 and 142 position receiver 26 within a range of folding positions along a width of receiver advance 102 proximate to a fold driver 144 such that fold driver 144 is positioned to be pushed against receiver 26 at fold line 122. FIG. 7 shows fold driver 144 driving receiver 26 through gap 146 to induce a partial fold in receiver 26 along fold line 122. FIG. 8 shows receiver 26 being driven by fold driver 144 into engagement with first fold rollers 150 and 152 which serve to further fold receiver 26 and which drive and rotate receiver 26 further into second fold rollers 154 and 156. This allows fold driver 144 to disengage from receiver 26. As shown in FIG. 9, the second fold rollers 154 and 156 further drive receiver 26 through a gap 158 to complete the folding of receiver 26 to the extent that such folding is desired. It will be appreciated that the extent of gap 158 can be varied to cause different levels of folding.

It will be appreciated from FIGS. 6-9, that when fold driver 144 applies pressure to receiver 26, receiver 26 is positioned by alignment features 140 and 142. Alignment features 140 and 142 position receiver 26 relative to side edges of receiver 26 in a manner that is consistent with the positioning of receiver 26 by registration features 126 and 128 during wetting of receiver 26 so that fold driver 144 applies pressure within hydrated area 124 during folding and further so that a fold is induced along fold line 122. This, in turn, helps to ensure that that fold rollers 150, 152, 154 and 156 fold receiver 26 along fold line 122. Other forms of alignment mechanisms can be used.

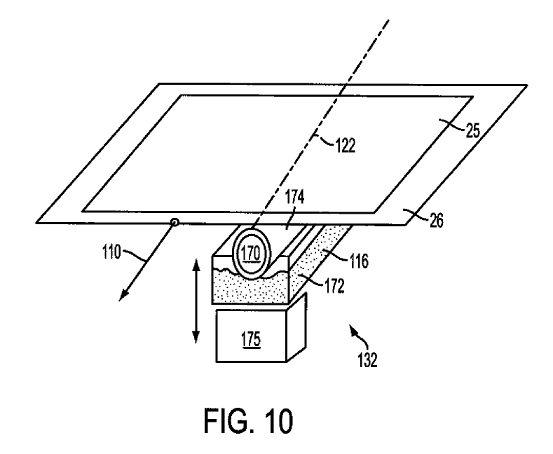

Water delivery system 132 can take any of a variety forms consistent with the requirements discussed above. For example, as is illustrated in FIG. 10, water system delivery 132 can take the form of a roller 170 that rolls in a water sump 172 at a speed that is sufficient to form a coating 174 of water 116 over roller 170. When water 116 is to be applied along fold line 122, roller 170 can be moved by a lifter 175 such as a motor driven system or a solenoid into a position wherein a portion of receiver 26 along fold line 122 engages the coating 174 to apply a line of water 116 along receiver 26 as receiver 26 is moved along the path of travel 110. Alternatively roller 170 can be made of materials that carry water from water sump 172 and that can apply such water to receiver 26 as roller 170 is rolled along in contact or near contact with receiver 26.

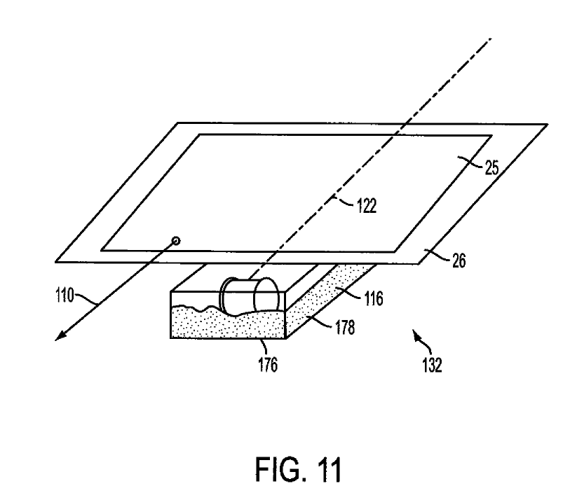

In the embodiment of FIG. 11, water delivery system 132 applies water 116 along the fold line 122 using a wheel 176 that is positioned to carry water 116 from sump 178 to receiver 26 to form a line of water 116 along fold line 122 as receiver 26 is moved along path of travel 110 by receiver advance (not shown).

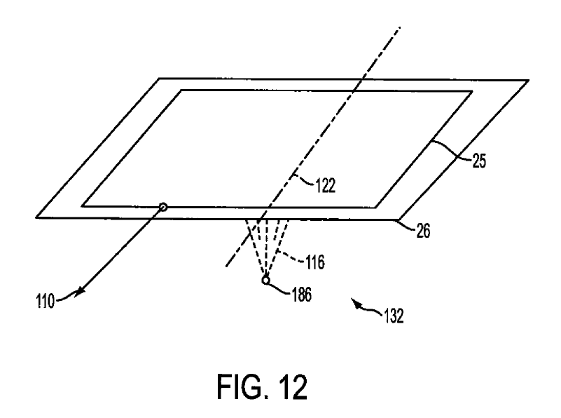

FIG. 12 shows still another embodiment of a water delivery system 132. In this embodiment, water 116 is applied to receiver 26 along fold line 122 using water jets 186 such as ink jet type nozzles or valved spray nozzles that spray or jet water 116 against receiver 26.

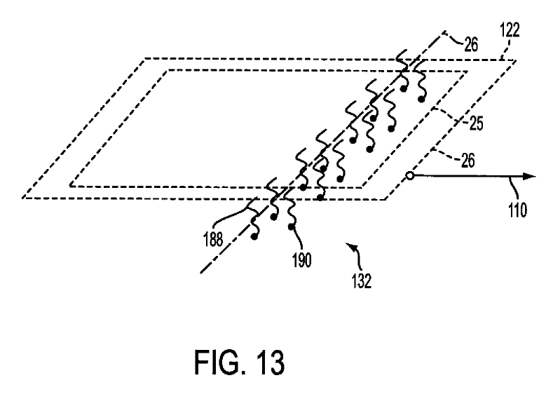

In still another embodiment, shown in FIG. 13, water delivery system 132 applies water 116 to receiver 26 along fold line 122 by way of steam jet 188 from one or more steam nozzles 190. This approach has advantage of applying heated water 116 which can more rapidly be absorbed by receiver 26.

Similarly, in any of the embodiments of wetting system 112, water 116 can be heated to assist with absorption by receiver 26 and or to otherwise provide heat that makes fibers in receiver 26 more flexible or less likely to crack. Water 116 can have a temperature in excess of about 70 degrees centigrade to achieve such an effect in certain embodiments. In this regard, water delivery system 132 can include a water heater that heats water 116 to a desired temperature.

In still another embodiment, water delivery system 132 can take the form of a snap line having a resilient cable or line that is maintained in a wet state and that can be rapidly brought against receiver 26 causing water to mechanically transfer water to receiver 26.

Toner 24 can comprise a polyester or other polymeric toner that is capable of absorbing water 116 and of softening or of increasing ductility when exposed to water 116. Accordingly, in certain embodiments, the amount of water 116 applied to receiver 26, the amount of time allowed for water 116 to be absorbed, or the temperature of water 116 that is applied can be set to help to soften the fused toner 24 in fused toner image 25 in an area proximate to fold line 122 in addition to having the effects that are described above on receiver 26.

It will be appreciated that water 116 can be applied to a receiver 26 having a toner image 25 along either an axis that is parallel to the path of travel 110 as shown in the various embodiments illustrated in FIGS. 5-13 or along another axis such as an axis that extends across path of travel 110.

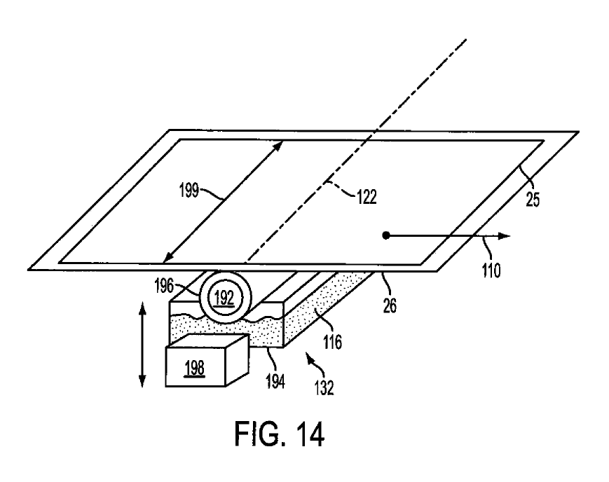

FIG. 14 shows an embodiment of water delivery system 132 that can apply water 116 across path of travel 110. In this embodiment, water delivery system 132 comprises a roller 192 that rolls in a water sump 194 at a speed that is sufficient to form a coating 196 of water 116 over roller 192. When water 116 is to be applied along fold line 122, roller 192 can moved by an actuator 198 such as a motor driven system or a solenoid to drive roller 192 and sump 194 from a non-wetting position into a position where water 116 is applied across a width 199 of receiver 26 along fold line 122 such that coating 196 of water 116 intersects receiver 26 to apply a line or path of water 116 across a width of receiver 26. Optionally, roller 192 can be made of materials that carry water 116 from water sump 194 and that can apply such water to receiver 26 as roller 192 is rolled along in contact or near contact with receiver 26.

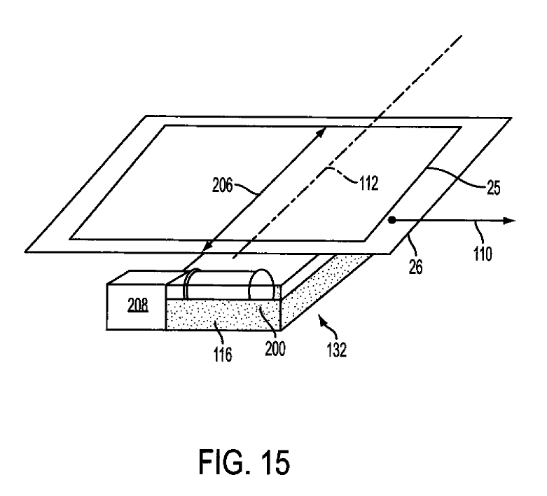

FIG. 15 shows another embodiment of water delivery system 132 that can apply water 116 across path of travel 110. In this embodiment, water delivery system 132 comprises a roller 200 that rolls in a water sump 202 at a speed that is sufficient to form a coating 204 of water 116 over roller 200. When water 116 is to be applied along fold line 122, roller 200 can be moved by an actuator 208 such as a motor driven system or a solenoid into across a width 206 of receiver 26 along fold line 122 such that coating 204 of water 116 applies a line or path of water 116 along receiver 26. Alternatively roller 200 can be made of materials that carry water from water sump 202 and that can apply such water to receiver 26 as roller 200 is rolled along in contact or near contact with receiver 26.

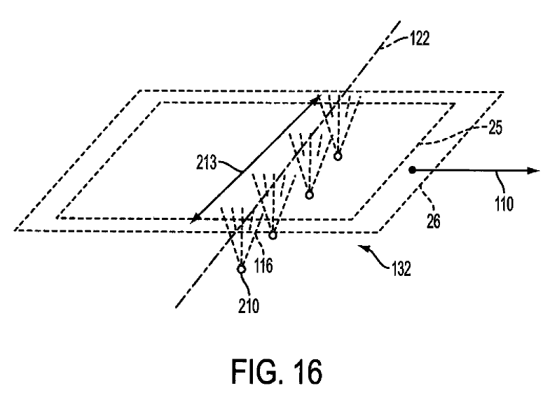

FIG. 16 shows still another embodiment of a water delivery system 132 that applies water 116 across path of travel 110. In this embodiment, water 116 is applied along fold line 122 using water jets 210 such as ink jet type nozzles or valved spray nozzles that spray or jet water 116 against receiver 26 in a pattern across a width 213 of receiver 26.

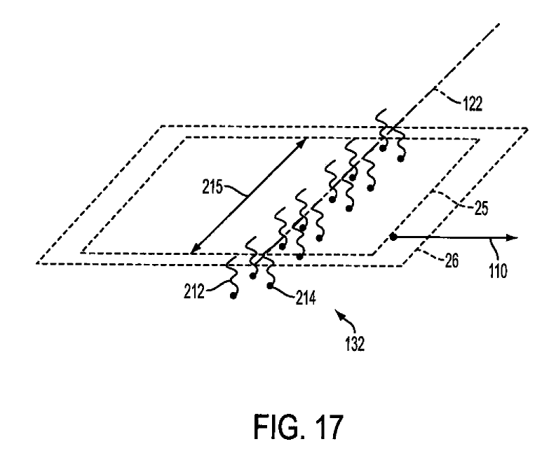

In still another embodiment, shown in FIG. 17, water delivery system 132 applies water 116 in the form of steam jets 212 from one or more steam nozzles 214 arranged in an array pattern across a width 215 of receiver 26. Similarly other embodiments of water applicator including a snap line type embodiment can be used in a similar fashion.

It will be understood that these various embodiments of water delivery system 132 can be used together or in sequence to provide hydrated areas 124 along more than one axis where it is desired to fold receiver 26 along many intersecting fold lines. Further, it will be understood that the embodiments of water delivery system 132 described herein are not limiting and that water delivery system 132 can comprise any mechanisms that provide water 116 in a way to form a hydrated area 124.

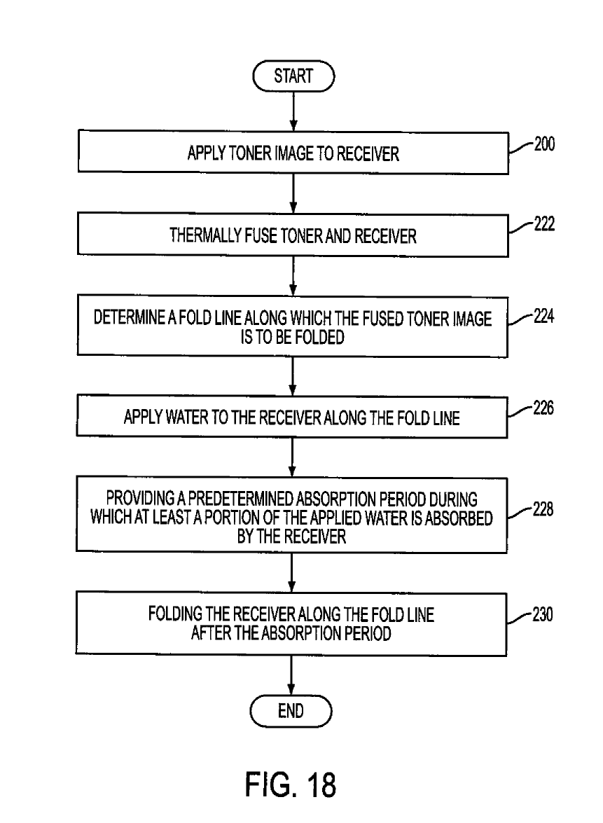

FIG. 18 shows an embodiment of a printing method that can be used by electrophotographic printer 20 to provide a folded receiver 26 having a toner image 25 with reduced risk of folding damage to toner image 25. As is shown in FIG. 18, a dry toner image is applied to a receiver (step 220) and the dry toner and receiver are thermally fused (step 222). A fold line 122 is the determined along which the fused toner image is to be folded (step 224). This can be done in a variety of ways. In one embodiment, this can be done by having controller 82 and/or control system 134 determine a fold line by analyzing image data used to make toner image 25 to identify one or more fold lines 122 based on the image analysis. In another embodiment, this can be done by analyzing print order information associated with the image data used to make the toner image to identify one or more image fold lines based analysis of the print order information.

Water 116 is then applied to receiver 26 along fold line 122 (step 226) and a predetermined absorption period is provided during which at least a portion of the applied water 116 is absorbed by receiver 26 (step 228). This reduces the extent to which receiver 26 cracks proximate to fold line 122 during folding or which, as discussed above, reduces the extent to which toner image 25 cracks during folding. Receiver 26 is folded along fold line 122 after the absorption period (step 230).

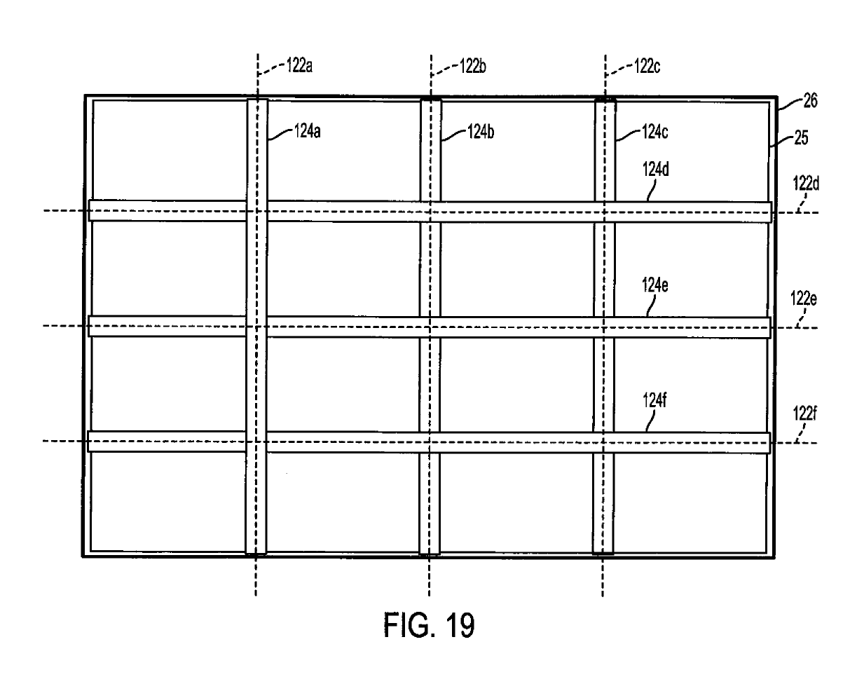

As is shown in FIG. 19, a pattern of fold lines 122a, 122b, 122c, 122d, 122e, and 122f are arranged along different axes to allow multiple folds of receiver 26 to be made. In such an embodiment, one or more water applicators 130 can be selectively activated to provide appropriate hydrated areas 124a, 124b, 124c, 124d, 124e and 124f. It will be appreciated that wetting processes will be managed to avoid overwetting at points of intersection of hydrated areas 124.

The invention has been described in detail with particular reference to certain preferred embodiments thereof, but it will be understood that variations and modifications can be effected within the spirit and scope of the invention.

### PARTS LIST

2 receiver
4 toner image
6 fibers
20 printer
22 print engine
24 toner
25 toner image
26 receiver
28 receiver transport
30 surface
32 receiver supply
36 motor
38 rollers
40 printing module
42 printing module
44 printing module
46 printing module
48 printing module
50 transfer subsystem
52 cleaning mechanism
60 fuser
82 controller
84 user input system
86 sensors
88 memory
90 communication system
92 external device(s)
94 output system
100 folding system
101 step
102 receiver advance
103 step
104 endless belt
105 step
106 rollers
108 motor
110 path of travel
112 wetting system
114 fold mechanism
116 water
129 fold controller
122 fold line
122a fold line
122b fold line
122c fold line
122e fold line
122f fold line
124 hydrated area
124a hydrated area
124b hydrated area
124c hydrated area
124e hydrated area
124f hydrated area
126 registration feature
128 registration feature
132 water delivery system
134 control system
136 first side of receiver
138 second side of receiver
140 alignment feature
142 alignment feature
144 fold driver
146 gap
150 first fold roller
152 first fold roller
154 second fold roller
156 second fold roller
158 gap
170 roller
172 water sump
174 coating
175 lifter
176 wheel
178 sump
186 water jets
188 steam jet
190 steam nozzles
192 roller
194 water sump
196 coating
198 actuator
199 width
200 roller
202 water sump
204 coating
206 width
208 actuator
210 water jets
212 steam jets
213 width
214 steam nozzles
220 step
222 step
224 step
226 step
228 step
230 step

What is claimed is:

1. A system for folding a receiver having a dry toner thermally fused thereon, the system comprising:
a wetting system adapted to apply water along a fold line; and
a fold mechanism folding the receiver along the fold line;
wherein the folding is performed after a predetermined absorption period during which at least a portion of the applied water is absorbed by the receiver to reduce the extent to which the receiver cracks proximate the fold line during folding.

2. The system of claim 1, further comprising a receiver transport system that is arranged to move the receiver from the wetting system to the fold mechanism so that the folding can begin only after the predetermined absorption period.

3. The system of claim 1, wherein the wetting system applies water to the receiver using a water jet.

4. The system of claim 1, wherein the wetting system comprises a snap line to apply water to the receiver.

5. The system of claim 1, wherein the wetting system comprise a steam nozzle adapted to apply water the receiver.

6. The system of claim 1, further comprising a water heater adapted to heat the water to a temperature that is greater than about 70 degrees Centigrade.

7. The system of claim 1, wherein the wetting system is operated so that the folding is performed after an absorption time during which the water absorbed by the receiver in the fold line forms a hydrated area having a relative humidity of at least about 70%.

8. The system of claim 1, further comprising a controller adapted to determine at least one setting controlling the application of water to the receiver based upon at least one of absorption properties of the receiver, a thickness of the receiver, the composition of the receiver, environmental conditions at the folding apparatus, the way in which the receiver has been fused, the temperature at which the receiver has been fused, the composition of the toner, or whether the water is to be applied to a toner covered portion.

9. The system of claim 1, wherein the water is applied to at least a portion of the toner image to increase ductility of the toner in the toner image during folding and wherein the predetermined absorption period is sufficient to allow the applied water to be absorbed by at least a portion of the toner image.

10. A printer comprising:
a print engine applying a dry toner image to a receiver;
a thermal fuser that heats the toner image and receiver to fuse the toner and bond the toner to the receiver;
a controller determining a fold line along which the fused toner image is to be folded;
a wetting system having a water applicator that applies water the receiver along the fold line;
providing a predetermined absorption period during which at least a portion of the applied water is absorbed by the receiver; and
a fold mechanism adapted to fold the receiver along the fold line,
wherein the folding is performed after a predetermined absorption period during which at least a portion of the applied water is absorbed by the receiver to reduce the extent to which the receiver cracks proximate the fold line during folding.

11. The printer of claim 10, wherein the controller determines a fold line comprises analyzing image data used to make the toner image to identify one or more image fold lines based on the image analysis.

12. The printer of claim 10, further comprising a controller that determines a fold line comprises analyzing image data used to make the toner image to identify one or more image fold lines based on the image analysis.

13. The printer of claim 10, further comprising a controller that determines a fold line by analyzing print order information associated with the image data used to make the toner image to identify one or more image fold lines based on analysis of the print order information.

14. The printer of claim 10, wherein the folding is performed after an absorption time during which the water absorbed by the receiver in the fold line forms a hydrated area having a relative humidity of at least about 70%.

15. The printer of claim 10, wherein the wetting system is adapted to apply water to the receiver to form a plurality of hydrated areas for a plurality of fold lines along different axes.

16. The printer of claim 10, further comprising features that position the receiver so that the fold mechanism folds the receiver along the fold line within a hydrated area.

17. The printer of claim 10, wherein the controller causes at least a portion of the water to be applied to the receiver is absorbed in a portion of the toner image to increase ductility of the toner in the toner image during folding and wherein the predetermined absorption period is sufficient to allow the applied water to be absorbed by the toner image.

18. The printer of claim 10, wherein the controller determines at least one setting controlling the application of water the receiver based upon at least one of absorption properties of the receiver, a thickness of the receiver, the composition of the receiver, environmental conditions at the folding apparatus, the way in which the receiver has been fused, the temperature at which the receiver has been fused, the composition of the toner, whether the water is to be applied to a toner covered portion of the receiver.

19. A folding system for a receiver having a toner image thermally fused thereto, the system comprising:
a wetting means for applying water to the fold line; and
a folding means for folding the receiver along the fold line;
wherein the folding is performed after an absorption time during which the water absorbed by the receiver in the fold line forms a hydrated area having a relative humidity of at least about 70%.

20. The folding system of claim 19, wherein the relative humidity of a hydrated area is less than about 90%.
